(19) United States
(12) Patent Application Publication
(10) Pub. No.: US 2019/0318329 A1
(43) Pub. Date: Oct. 17, 2019

(54) INTERNET-OF-THINGS ENABLED REAL-TIME EVENT PROCESSING

(71) Applicant: Bank of America Corporation, Charlotte, NC (US)

(72) Inventors: Joseph Benjamin Castinado, North Glenn, CO (US); Charles Russell Kendall, Snoqualmie, WA (US)

(21) Appl. No.: 15/951,981

(22) Filed: Apr. 12, 2018

(51) Int. Cl. G06Q 20/10; H04L 9/06; H04L 29/08; G06Q 20/40

(52) U.S. Cl. CPC G06Q 20/102; G06Q 20/4014; H04L 67/1042; H04L 9/0637

(57) ABSTRACT

The present invention provides for real-time (or near real-time) processing of computing events that are triggered by a threshold level being met by data detected at Internet-of-Things devices and, in response to meeting the threshold, communicating an event processing request to a real-time event-mediating channel. The real-time event-mediating channel is capable of processing such events in real-time or near real-time by storing event commitment records in a distributed blockchain network that authenticates a user associated with an event and authorizes an event facilitating entity to access a resource depository associated with the event.

### FIELD

In general, embodiments of the invention relate to real-time processing, and more specifically, triggering real-time event processing based on monitoring a sensor at an Internet-of-Things (IoT) device and determining that the output of the sensor satisfies a predetermined event processing rule.

### BACKGROUND

Systems for providing communications between and amongst devices are known where inter-related communication devices, often referred to as Internet-of-Things (IoT) or smart devices, may include communications modules, processors and applications that allow the devices to communicate with one another, and with other devices and/or systems, over a network. Such systems allow the devices to collect and exchange data. Collection of data is made possible by embedding sensors or other detection mechanisms in the IoT.

In certain instances the entity that receives the data may perform a computing event/function based on the data. In specific instances, the computing event may typically occur as series of events performed over a period of time, such as events that occur over a period of a few days or within a twenty-four hour/day period. The delay in performing the computing events may be due to the sheer volume of events being processed, the need to verify the authenticity of the entity requesting the event/function and the authorization to perform the event/function, standard operating procedures or other factors.

Therefore, a need exists enable real-time, or near real-processing of events triggered by data collected and received from IoT or smart devices.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, for real-time (or near real-time) processing of computing events that are triggered by a threshold level being met by data collected at Internet-of-Things devices (i.e., so-called “smart devices”) and, in response to meeting the threshold, communicating an event processing request to a real-time event-mediating channel. The real-time processing of such computing events is made possible by storing event commitment records in a distributed blockchain network that authenticates a user associated with an event and authorize an event facilitating entity to access a resource depository associated with the event.

A system for real-time event processing defines first embodiments of the invention. The system includes a distributed communication network comprising a real-time event-mediating channel. The system further includes a distributed blockchain network comprising a plurality of decentralized nodes configured to store a plurality of predetermined event commitment records. The records are configured to authenticate a user and facilitate an event by authorizing a first event facilitating entity associated with the user to access a first resource depository associated with the user at the first event facilitating entity. In addition the system includes at least one Internet-of-Things (IoT) communication device that includes a processor, a memory storing instructions and in communication with the processor and one or more sensors in communication with the processor. The processor is configured to execute the instructions stored in the memory to receive, via the distributed communication network, information related to one of the predetermined event commitment records. The information includes (i) an event triggering rule associated with at least one of the sensors, and (ii) an event processing rule designating the real-time event-mediating channel for processing an associated event request. The processor is further configured to monitor an output of the at least one of the sensors to determine when the output satisfies the event triggering rule, and, in response to determining that the output satisfies the event triggering rule, initiate wireless communication, via the distributed communication network to the real-time event-mediating channel, of an event request associated with the one of the plurality of predetermined event commitment records. Further, the real-time event-mediating channel is configured to, in response to receiving the event request, complete the event in real-time or near real-time to receiving the event request.

In specific embodiments of the system the event is a transfer of resources from the first resource depository to a second resource depository associated with a second event facilitating entity. As such, real-time or near-real time processing provides completing transfer of the resources from the first resource depository to a second resource depository associated with a second event facilitator in real-time or near-real time.

In further specific embodiments of the system, the event triggering rule is a minimum threshold limit associated with a consumable product consumed by the IoT communication device or a device associated with the IoT communication device. In such embodiments of the invention, the processor of the IoT communication device may be further configured to, in response to determining that the output satisfies the event triggering rule, execute the instructions to initiate wireless communication, via the distributed communication network, of an acquisition request to a designated consumable product provider to acquire the consumable product.

In still further embodiments of the system, the event triggering rule is a threshold limit associated with performance of a service performed by a service provider.

In other specific embodiments of the system the at least one IoT communication device further comprises a plurality of inter-related IoT communication devices. In such embodiments of the invention the plurality of the inter-related IoT communication devices may each have an associated event triggering rule associated with one or more sensors in the IoT device, such that, a minimum number, or in some instances all, of the plurality of IoT devices must satisfy the rule (i.e., the output of the sensors must the rule) as a trigger for initiating wireless communication, via the distributed communication network to the real-time event-mediating channel, of an event request associated with the one of the plurality of predetermined event commitment records. In specific embodiments of the invention, the plurality of IoT devices must satisfy the rule in a predetermined sequence as a trigger for initiating wireless communication, via the distributed communication network to the real-time event-mediating channel, of an event request associated with the one of the plurality of predetermined event commitment records. In such embodiments of the invention, the processors of the inter-related IoT communication devices, are further configured to, in response to determining that the output of the at least sensor of one of the plurality of inter-related IoT communication devices satisfies the inter-related IoT communication device-specific event triggering rule, initiate wireless communication, via the distributed communication network, of a notification to at least one of the plurality of inter-related IoT communication devices that notifies the at least one the inter-related IoT communication device that the output satisfies the event triggering rule.

In still further specific embodiments of the system, the real-time event-mediating channel is further configured to, in response to receiving the event request, authenticate the user and authorize the first event facilitating entity associated with the user to access the first resource depository at the first event facilitating entity based on the one of the predetermined event commitment records stored in the distributed blockchain network. In such embodiments of the system, the real-time event-mediating channel is may access the one of the predetermined event commitment records in the distributed blockchain network to authenticate the user and authorize the first event facilitating entity associated with the user to access the first resource depository at the first event facilitating entity or communicate an authentication and authorization request to the first event facilitating entity to access the one of the predetermined event commitment records in the distributed blockchain network to authenticate the user and authorize the first event facilitating entity to access the first resource depository at the first event facilitating entity.

An Internet-of-Things (IoT) communication apparatus devices second embodiments of the invention. The apparatus includes at least one processor, a memory storing instructions and in communication with the at least one processor, a wireless communication mechanism in communication with one or more of the at least one processors, and at least one sensor in communication with one or more of the at least one processors. The processor is configured to execute the instructions to receive, via the wireless communication mechanism, information related to a predetermined event commitment record stored within a distributed blockchain network. The information includes (i) an event triggering rule associated with at least one of the sensors, and (ii) an event processing rule that designates a real-time event-mediating channel for processing an associated event request. The processor is further configured to execute the instructions to monitor an output of the at least one of the sensors to determine when the output satisfies the event triggering rule, and, in response to determining that the output satisfies the event triggering rule, initiate communication, via the wireless communication mechanism, of an event request to the real-time event-mediating channel.

In specific embodiments of the apparatus, the event is a transfer of resources from a first resource depository associated with a first resource transfer entity to a second resource depository associated with a second resource transfer entity. As such, real-time or near-real time processing facilitated by the real-time event facilitating channel provides for completing the transfer of the resources from the first resource depository to a second resource depository associated with a second event facilitator in real-time or near-real time.

In other specific embodiments of the apparatus, the event triggering rule is one of (i) a minimum threshold limit associated with a consumable product consumed by the IoT communication device or a device associated with the IoT communication device or (ii) a threshold limit associated with performance of a service performed by a service provider.

In still further specific embodiments of the apparatus, the processor is further configured to, in response to determining that the output satisfies the event triggering rule, initiate wireless communication, via the distributed communication network, of a notification to at least one of a plurality of inter-related IoT communication devices that notifies the at least one of the inter-related IoT communication devices that the output satisfies the event triggering rule. Such notification is used in those embodiments of the invention in which a minimum number of IoT apparatus must satisfy an IoT apparatus-specific event rule and/or an predetermined sequence of satisfying IoT apparatus-specific event rules must occur as a trigger for initiating wireless communication, via the distributed communication network to the real-time event-mediating channel, of an event request associated with the one of the plurality of predetermined event commitment records.

A computer program product including a non-transitory computer-readable medium defines third embodiments of the invention. The computer-readable medium includes a first set of codes for causing a computer to receive, via wireless communication, information related to a predetermined event commitment records stored in distributed blockchain network. The information includes (i) an event triggering rule associated with at least one sensor of an Internet-of-Things (IoT) device, and (ii) an event processing rule that designates a real-time event-mediating channel for processing an associated event request. The computer-readable medium further includes a second set of codes for causing a computer to monitor an output of the at least one of the sensors to determine when the output satisfies the event triggering rule. Additionally, the computer-readable medium further includes a third set of codes for causing a computer to, in response to determining that the output satisfies the event triggering rule, initiate communication, via wireless communication, of an event request to a real-time event-mediating channel.

In specific embodiments of the computer program product in which the event is transfer of resources, in response to receiving the event request, the real-time event mediating channel is configured to complete, in real-time or near real-time to receiving the event request, a transfer of resources from a first resource depository associated with a first resource transfer entity to a second resource depository associated with a second resource transfer entity.

Thus, systems, apparatus, methods, and computer program products herein described in detail below provide real-time (or near real-time) processing of computing events that are triggered by a threshold level being met by data detected at Internet-of-Things (IoT) devices (i.e., so-called “smart devices”) and, in response to meeting the threshold, communicating an event processing request to a real-time event-mediating channel. The real-time event-mediating channel is capable of processing such events in real-time or near real-time by storing event commitment records in a distributed blockchain network that authenticates a user associated with an event and authorizes an event facilitating entity to access a resource depository associated with the event.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram of an exemplary distributed blockchain network including a plurality of decentralized nodes, in accordance with embodiments of the present invention;

FIG. 2 provides a schematic diagram of a system for performing real-time or near real-time processing of an event, in accordance with embodiments of the present invention;

FIG. 3 provides a schematic diagram of a system for performing real-time or near real-time processing of an event in response to a threshold being met at an Internet-of-Things (Iot)/smart device, in accordance with embodiments of the present invention;

FIG. 4 provides a schematic diagram of a system for performing real-time or near real-time processing of a resource transfer event in response to a threshold being met at an Internet-of-Things (Iot)/smart device, in accordance with embodiments of the present invention;

FIG. 5 provides a block diagram of an Internet-of-Things (Iot)/smart apparatus configured to trigger real-time or near real-time processing of a computing event, in accordance with embodiments of the present invention; and

FIG. 6 provides a flow diagram of a method for real-time or near real-time processing of an event in response to a threshold being met at an Internet-of-Things (Iot)/smart device, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for real-time (or near real-time) processing of computing events that are triggered by a threshold level being met by data detected at Internet-of-Things (IoT) devices and, in response to meeting the threshold, communicating an event processing request to a real-time event-mediating channel. The real-time event-mediating channel is capable of processing such events in real-time or near real-time by storing event commitment records in a distributed blockchain network that authenticates a user associated with an event and authorizes an event facilitating entity to access a resource depository associated with the event.

In specific embodiments of the invention, the computing event that is triggered is a resource transfer between a first resource depository held at a first event facilitator and a second resource depository held at a second event facilitator.

In specific embodiments of the invention, the event commitment records include rules for facilitating the computing event. For example, the rules may include one or more event triggering rules that define the criteria/thresholds for data detected at one or sensors associated with or otherwise included in the IoT devices. In addition, the rules may include an event processing rule, which may be configured to define the event as being processed by the real-time event-mediating channel.

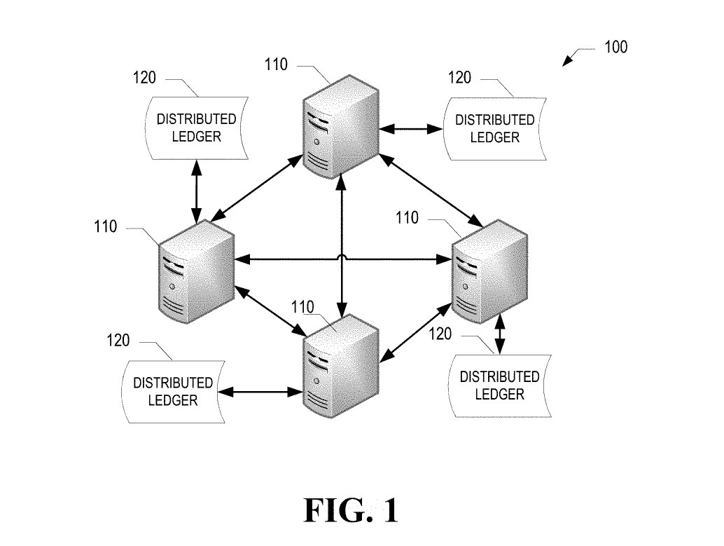

Referring to FIG. 1, a schematic diagram is provided of an exemplary distributed blockchain network 100, in accordance with embodiments of the present invention. A blockchain network 100 (otherwise referred to as a “block chain”) is a distributed database that maintains, e.g., a list of data records, or the like. In specific embodiments of the invention the data records may include event commitment records, including smart contracts or the like which have been formed between two users requiring resource transfer between two different resource depositories held at two different event facilitators. In addition, the event commitment records include authentication and authorization associated with performing the computing event, such as the resource transfer and rules associated with performing the event (e.g., triggering criteria, processing mechanisms and the like). The security of the data maintained within a blockchain is enhanced by the distributed nature of the block chain. A blockchain typically includes several nodes 110, which may be one or more systems, machines, computers, databases, data stores or the like operably connected with one another. In some cases, each of the nodes 100 or multiple nodes 100 are maintained by different entities. A blockchain typically works without a central repository or single administrator. One well-known application of a block chain is the public ledger of transactions for cryptocurrencies such as used in bitcoin. The data records recorded in the block chain are enforced cryptographically and stored on the nodes 100 of the block chain.

A blockchain provides numerous advantages over traditional databases. A large number of nodes 100 of a blockchain may reach a consensus regarding the validity of resources maintained with a block of the blockchain, e.g., an event commitment record maintained on a ledger 120, authorization/authentication to process an event, such as a resource transfer or the like. Additionally, when multiple versions of a data record exits on the ledger 120, multiple nodes 110 can converge on the most up-to-date version of the data record (e.g., event commitment records). For example, in the case of an event commitment record, any node 110 within the block chain 100 that stores a record, such as an event commitment record can determine within a level of certainty whether record can be authenticated/authorized to take place and become final by confirming that no conflicting records are confirmed by the block chain elsewhere.

The blockchain chain typically has two primary types of records. The first type is the record type, which consists of the actual data stored in the block chain. The second type is the block type, which are records that confirm when and in what sequence certain events became recorded as part of the blockchain. Records, such as event commitment record and the events associated therewith are created by participants using the blockchain in its normal course of business, for example, when an event commitment is formed, a block(s) is created by users known as “miners” who use specialized software/equipment to create blocks. Holders (also, referred to as users) of a block of the blockchain form the event commitments and the related event commitment records are passed around to various nodes of the block chain. A “valid” event commitment record or related event is one that can be validated based on a set of rules that are defined by the particular system implementing the blockchain. For example, in the case of resource transfers, a valid resource transfer is one that authenticates the user and authorizes the event facilitator to access the resource depository holding the resources to be transferred.

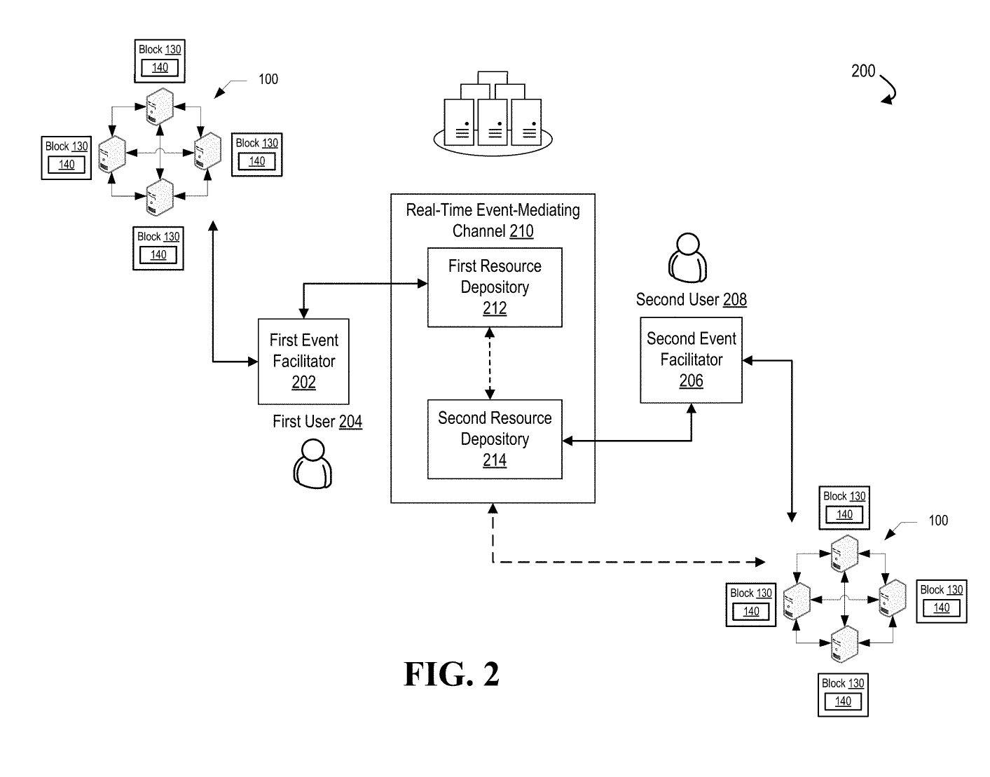

A blockchain 100 is typically decentralized—meaning that a distributed ledger 120 (i.e., a decentralized ledger) is maintained on multiple nodes 110 of the blockchain 100. One node in the block chain may have a complete or partial copy of the entire ledger 120 or set of records and/or blocks on the block chain. Events are initiated at a node 110 of a blockchain 100 and communicated to the various nodes 110 of the blockchain 100. Any of the nodes 110 can validate a record or an associated event, add the record or the details of the event to its copy of the blockchain 100, and/or broadcast the record or details of the event, its associated validation (in the form of a block) and/or other data to other nodes 110. The block chain 100 shown in FIG. 1 is configured to perform one or more of the steps or functions performed by the system shown in FIGS. 2-4.

Referring to FIG. 2 a schematic diagram is provided of a system 200 for real-time processing of events, in accordance with embodiments of the present invention. As used herein, a “real-time processing of events/event processing” refers to a computing event occurring in real or near real-time to initiating the request for the event. In specific embodiments in which the event is resource transferring, the resource transfer between users and/or entities participating in and leveraging a resource transfer network, the resource transfer is completed at or very close in time to the time of the initiation of the resource transfer. Real-time event processing is made possible by implementation of a blockchain 100 including a plurality of nodes 110 that store blocks 130 including event commitment records 140. The event commitment records 140 are configured to provide authentication of the user conducting the event and authorization for the event first facilitator 202 to access the first resource depository 212 to retrieve the resources that are being transferred.

In the illustrated environment of FIG. 2, a first user 204 is associated with a first event facilitator 202 and a second user 208 is associated with a second event facilitator 206. A real-time event-mediating channel, such as a clearinghouse or the like, includes or otherwise has access to first resource depository 212 associated with the first event facilitator 202 and a second resource depository 214 associated with the second event facilitator 206. The first resource depository 212 and the second resource depository 214 are accessible by each associated event facilitator 202 and 206 and the event-mediating channel 210 which acts as a trusted intermediary during completion of the event. In specific embodiments of the invention, event processing provides for resources being transferred by one of the event facilitators 202 or 206 to and from their associated resource depository 212 or 214. Transfers between the first resource depository 212 and the second resource depository 214 are administered and occur in real-time or near real-time, by the based on the event-mediating channel 210 communicating with the blockchain network 100 to access the event commitment record 140 stored in block 130 that is associated with a requested event. By accessing the event commitment record 140 which includes user authentication and authorization for the event facilitator to access the associated resource depository, the event-mediating channel 210 is able to, in real-time or near-real time, authenticate the user and provide the event facilitator access to the resource depository at which the resources being transferred are being held. In this regard, the ability of the blockchain network to store an event commitment record that serves to validate the authenticity of the user and grant access to/authorize the event facilitator to access the associated resource depository provides the impetus for conducting the event, e.g., the resource transfer, in real-time or near real-time.

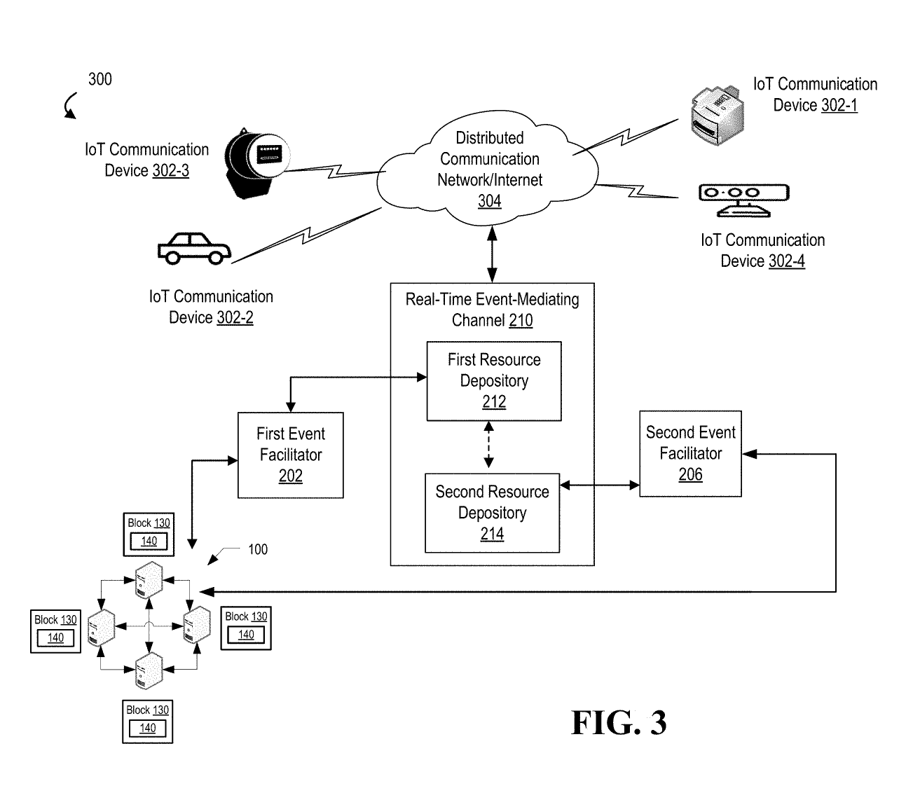

Referring to FIG. 3, a schematic diagram of a system 300 for performing real-time or near real-time processing of an event in response to a threshold being met at an Internet-of-Things (Iot)/smart device. The system 300 implements the systems 200 for real-time processing of events shown and described in relation to FIG. 2. The request for performing the event is received by the real-time event mediating channel 210 from an Internet-of-Things (Iot) device 302, otherwise referred to as a smart device via a distributed communication network 304, such as the Internet and/or a cellular network or the like. While not shown in FIG. 3, intermediary devices/apparatus, such as routers, gateways, base stations and the like may be implemented to facilitate the communication of the event processing request from the IoT device 304 to the real-time event-mediating channel 210.

Each of the IoT devices 302 are equipped or otherwise associated with one or more sensors (not shown in FIG. 3) or means for detecting a parameter that is associated with triggering a processing event. The IoT devices are configured to receive information associated with an event commitment record, such information includes, but is not limited to, one or more event triggering rules and an event processing rule. The event triggering rule is associated with one or more of the sensors in or associated with one or more of the IoT devices and defines an output of the sensor(s) that is required to be met (i.e., a threshold limit or the like) to trigger communication of an event request to the real-time event-mediating channel 210 that includes, at a minimum, identification of the event commitment record associated with the event being requested. As shown in FIG. 3 the IoT devices 302 may include, but are not limited a, device having consumable products 302-1, such as printer or the like, a vehicle 302-2, a meter device 302-3 capable of determining usage of a utility (i.e., electricity, water, gas, network bandwidth or the like), and any other device capable of detecting/measuring a parameter 302-4.

In this regard, the IoT device 302 is configured to, via an event requesting module or some other software related instructions, monitor the sensor(s) associated with the event triggering rule to determine when the output of the sensors or other parameter measuring mechanism meet the requisite output (i.e., achieve the designated threshold). Further, the IoT device 302 is configured to, via an event requesting module or some other software related instructions, generate and initiate communication (typically wireless communication via the distributed communication network 304, of an event processing request to the real-time event-mediating channel 210. As previously discussed, in response to receiving the event processing request, which identifies the event commitment record 140, the real-time event-mediating channel 210 processes the event in real-time or near real-time based on communicating with the blockchain network 100 to access the event commitment record 140 which provides for authentication of the user requesting the event and authorization of the event facilitating entity 202 to access the resource depository 212 as a means of initiating the event process. The real-time event-mediating channel 210 may directly access the blockchain network 100 storing the event commitment record 140 or the event-mediating channel 210 may communicate requests to a respective event facilitator 202, which in turn, accesses the blockchain network 100 storing the event commitment record 140.

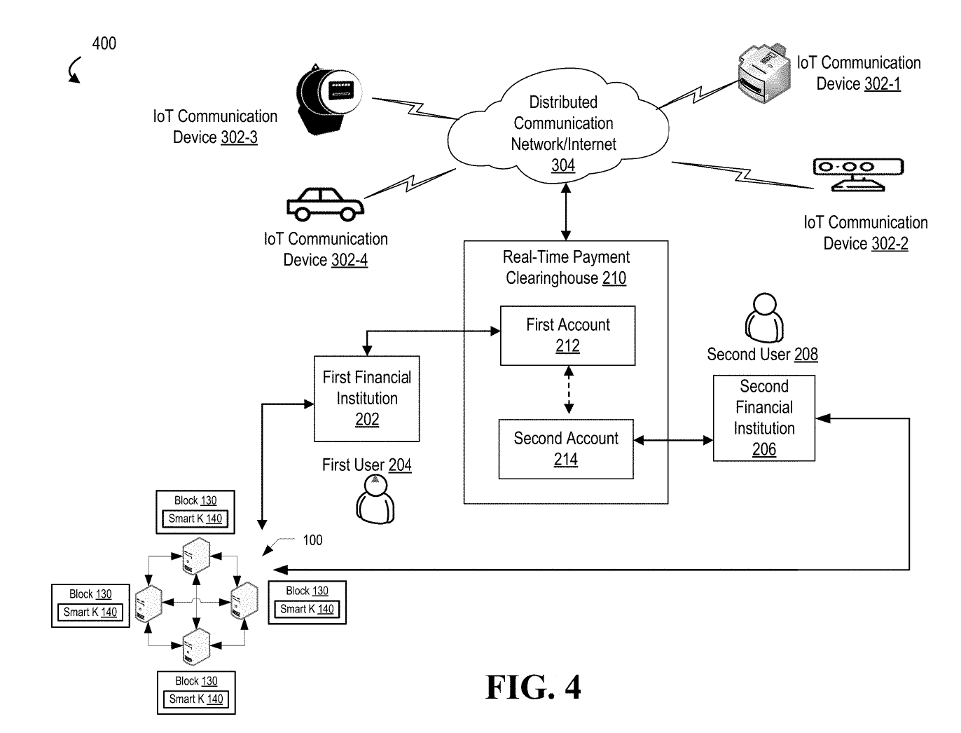

Referring to FIG. 4, a schematic diagram of a system 400 for performing real-time or near real-time processing of a payment/fund transfer event in response to a threshold being met at an Internet-of-Things (Iot)/smart device. The system 300 implements the systems 200 for real-time processing of events shown and described in relation to FIG. 2. In such embodiments of the invention the “real-time event” refers to a payment or fund transfer between users and/or the financial institutions participating in and leveraging a settlement network operating in real or near real-time (e.g., a real-time payment clearinghouse 210), wherein settlement of the payment/fund transfer occurs at or very close in time to the time of the interaction. As such the real-time payment/fund transfer enables participants to initiate fund transfers, receive settlement for fund transfers, and make available to a receiving participant funds associated with the fund transfers in real-time, such that the fund transfer is final and irrevocable.

Real-time event processing, such as fund transfers or the like provide marked improvements over conventional interaction clearing and payment settlement methods (e.g., automated clearing house (ACH), wire, or the like) which can require several hours, days, or longer to conduct the entire settlement process (i.e., receive, process, authenticate a payment request, and make funds available to the receiving participant which may, in total, require several back-and-forth communications between involved financial institutions). In this regards, in some cases, conventional payment/fund transfer settlement methods may not be executed until the end of the business day (EOB), wherein payments are settled in batches between financial institutions.

Real-time event processing, such as real-time payment/fund transfers reduce settlement time by providing pre-authentication of the user or authentication of the user at the time of a requested event in order to enable instantaneous or near-instantaneous settlement (i.e., completion of the event) between financial institutions at the time of the event processing, wherein resources or funds may be made immediately available to a receiving participant (i.e., payee) following completion of the event. Examples of processing events, such as payment/fund transfer events that may benefit from real-time processing include, but are not limited to, business to business interactions (e.g., supplier payments), business to consumer interactions (e.g., legal settlements, insurance claims, employee wages), consumer to business interactions (e.g., bill pay, hospital co-pay, payment at point-of-sale), and peer to peer (P2P) interactions (e.g., repayment or remittance between friends and family). In a specific example, a real-time event processing may be used for payment of a utility bill on the due date of the bill to ensure payment is received on-time and avoidance of accruement of additional fees due to late payment. In another example, real-time event processing, such as real-time payment/fund transfers may be especially beneficial for small entities and users (e.g., small merchants/businesses) that may have a heavier reliance on short-term funds and may not prefer to wait days for transaction settlements.

Real-time event processing, such as payment/fund transfer processing not only provide settlement immediacy, but also provide assurance, fraud reduction, and bank-grade security to payments due to the inherent nature of the payment (i.e., the user authentication and event facilitator authorization provided by the blockchain network). Further, real-time event processing, such as payment/fund transfer processing may reduce event processing costs due to the simplified nature of required communication when compared to conventional event processing, such as convention payment/fund transfer settlement methods. In some embodiments, real-time interaction systems further include information and conversation tools that event facilitators may utilize to enhance an event processing experience for participants.

A system leveraging a real-time interaction event network allows for an interaction, transaction, payment, or the like to be completed between participating parties (e.g., financial institutions and/or their customers) via an intermediary real-time event-facilitating channel 210, such as a real-time payment clearinghouse acting in the role of a neutral party. Participant resource depositories, such as accounts are held at or accessible via the clearinghouse and administered by both the participant/user and the clearing house. In this way, the clearing house is able to transfer resources or funds between the participant accounts on behalf of the participants in order to settle interactions.

In the illustrated of FIG. 4, a real-time payment clearinghouse 210 includes or has access to a first account 212 associated with the first financial institution 202 and a second account 214 associated with the second financial institution 206. In this regard, the first account 212 and the second account 214 are accessible by each associated financial institution 202 206 and the clearinghouse 210 which acts as a trusted intermediary during settlement between the financial institutions. Funds may be transferred by each financial institution to and from their associated account. Transfers between the first account 212 and the second account 214 are administered by the clearinghouse 210 based on user authentication and financial institution authorization received from the smart contract 140 stored in a block 130 of the blockchain network 100.

In specific embodiments, the first user 204 and the second user 208 are participants of a real-time payment/fund transfer system, wherein the first user 204 (i.e., the payor) initiates a fund transfer to the second user 208 (i.e., the payee). In a specific example, the first user 204 is required to initiate the payment/fund transfer from the first financial institution 202, wherein the blockchain 100 provides authentication information to authenticate the identity of the first user 204 and to authorize the first financial institution 202 to access the first account 212.

As a prerequisite to providing user authentication within the blockchain 100, the first user 204, as the sending participant (i.e., payor), may be required to authenticate his or her identity by providing information or credentials to the associated first financial institution 202. For example, authentication information may include account numbers, routing numbers, PIN numbers, username and password, date of birth, social security number, or the like, or other authentication information as described herein.

Upon initiating a payment/fund transfer event (i.e., the payment/fund transfer request is received by the clearing house from the IoT device), the first user 204 becomes obligated to pay the amount of the interaction, wherein the interaction cannot be canceled by the first user 204 following initiation and transmission of payment/fund transfer request. In specific embodiments of the invention, the second user 208, as the receiving participant (i.e., the payee), may receive a communication acknowledging payment and requesting the second user 208 to accept payment, following similar user authentication requirements. Communication between participants for the payment/fund transfer event may be transmitted between the financial institutions via the clearinghouse 210 which directs the payment to the appropriate financial institution associated with the receiving participant. The transfer of funds occurs between the financial institution accounts 212 and 214 associated with the financial institutions 202 and 206 on behalf of their associated users, wherein the interaction may be settled immediately, concurrent with the processing of the event (i.e., processing of the payment/fund transfer). As settlement occurs between the representative financial institutions 202 and 206, debiting and crediting of individual user accounts may be managed at each financial institution 202 and 206 with their associated customers. As the interaction is settled immediately, funds may be made available for use in real or near real-time.

It should be understood that while the illustrated embodiment of FIG. 4 depicts only first and second users 204 and 208, first and second financial institutions 202 and 206, and first and second accounts 212 and 214, other embodiments of a real-time payment processing network may comprise a plurality of accounts associated with a plurality financial institutions. In some embodiments, the system 400 may further comprise more than one real-time payment clearinghouse 210 that receive and process interaction requests as described herein. Financial institutions may include one or more community banks, regional banks, credit unions, corporate banks, direct connect financial institutions, and the like.

In those embodiments of the invention in which the processing event is a payment/fund transfer event, the event triggering rule is a rule that triggers a payment/fund transfer request. For example, if the IoT device is a device that has a consumable product 302-1, such as printer that consumes ink, sensors in the device may monitor the consumption of the ink and when the ink level falls below a specified minimum level, a payment request, in conjunction with an order/purchase request for re-ordering ink, is communicated to the real-time payment clearinghouse 210 for real-time payment (i.e., settlement completed in real-time or near real-time). Similarly. If the IoT device is a vehicle 302-4 the sensors may monitor the consumption of consumable products, fluid levels such as oil, cooling/antifreeze fluid, filters, hoses, pumps and any other vehicle part having an exhaustive lifecycle and when the output of the sensor meets or exceeds the threshold limit associated with re-ordering the vehicle part or consumable product a payment request, in conjunction with an order/purchase request for re-ordering ink, is communicated to the real-time payment clearinghouse 210 for real-time payment (i.e., settlement completed in real-time or near real-time). In other embodiments of the invention, the payment request may be associated with a service that is provided to a user, such a house or business cleaning service, a lawn/yard or swimming pool maintenance service or the like. In such embodiments of the invention, the IoT devices 302-2 may include sensors that monitor the cleanliness of the house/business, the length of the lawn, the chemical make-up of the pool and the pool, such that once a satisfactory factory level of compliance to cleanliness/maintenance requirements is achieved, a payment request is communicated to the real-time payment clearinghouse 210 for real-time payment (i.e., settlement completed in real-time or near real-time) of the service provider (e.g., the cleaning/lawn/pool maintenance service or the like). In other embodiments of the invention, in which the IoT device is metering device 302-3, in which sensors are configured to monitor usage of a utility (e.g., electricity, gas, water, computing network or the like), a specified amount of usage or a specified date of the week, month or the like may trigger communication of a payment request to the real-time payment clearinghouse 210 for real-time payment (i.e., settlement completed in real-time or near real-time) of the utility provider (e.g., electric/gas/water company, Internet Service Provider (ISP) or the like).

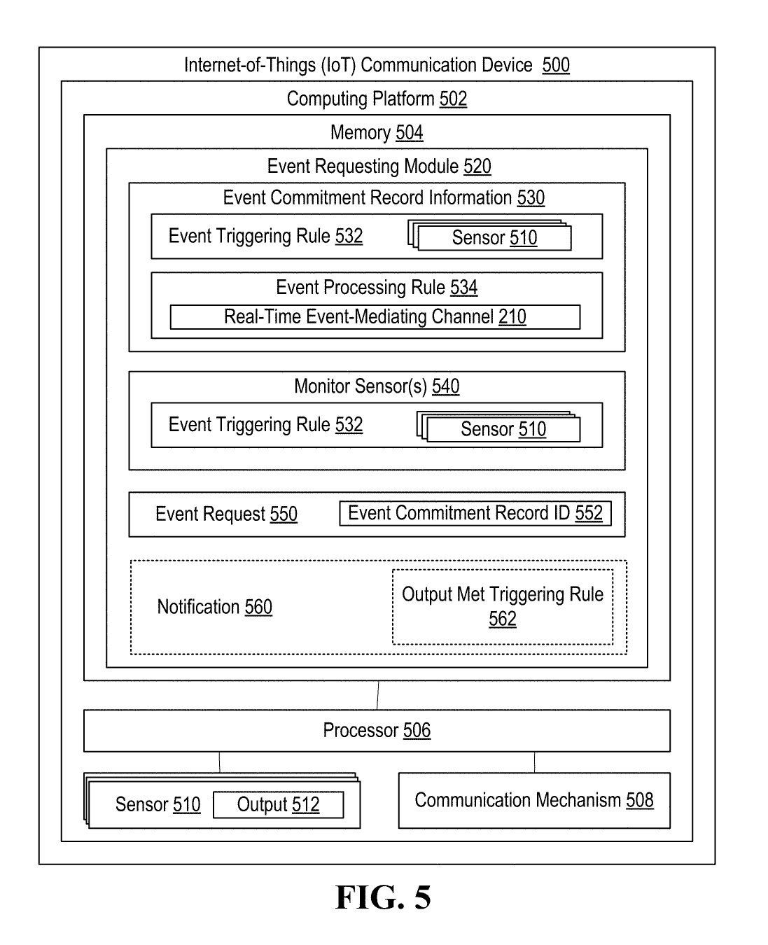

Referring to FIG. 5 a block diagram is presented of an IoT communication device/apparatus 500, in accordance with embodiments of the present invention. In addition to providing more details for the IoT communication device/apparatus 500 and systems 200, 300 and 400, FIG. 5 provides various optional embodiments of the device/apparatus and systems. The IOT device/apparatus 500 includes a computing platform 502 having a memory 504 storing instructions therein, a processor 506 in communication with the memory and one or more sensors 510 in communication with the memory 504. The memory 504 may comprise volatile and non-volatile memory, such as read-only and/or random-access memory (RAM and ROM), EPROM, EEPROM, flash cards, or any memory common to computer platforms). Moreover, memory 504 may comprise cloud storage, such as provided by a cloud storage service and/or a cloud connection service.

The processor 506 may be application-specific integrated circuits (“ASICs”), or other chipsets, logic circuits, or other data processing device(s). Processor 506 may execute an application programming interface (“API”) (not shown in FIG. 5) that interfaces with any resident programs (i.e., event requesting module 520) stored in the memory 504 of the computing platform 100. Processor 506 may include various processing subsystems (not shown in FIG. 5) embodied in hardware, firmware, software, and combinations thereof, that enable the functionality of the computing platform 502 and the operability of the computing platform 503 on the distributed computing network 304 (shown in FIGS. 3 and 4). For example, processing subsystems allow for initiating and maintaining communications and exchanging data with other networked devices (i.e., event-mediating channel 210). For the disclosed aspects, processing subsystems of processor 506 may include any subsystem used in conjunction with event requesting module 520 and related, codes, routines, sub-routines, algorithms, sub-algorithms, modules, sub-modules thereof.

Sensors 510 may include any device, and/or firmware/software capable of detecting a condition or parameter relevant to triggering an event. The condition or parameter may be inherent to the IoT device (e.g., a utility metering device, a device with consumable products or the like) or the condition or parameter may be related to the surrounding environment (e.g., a property of a room or other area).

The computing platform 502 additionally includes communication mechanism 508 embodied in hardware, firmware, software, and combinations thereof, that enables electronic communications between the computing platform 502 and other platforms, apparatus and/or devices, such as event-mediating channel 210 (shown in FIGS. 2-4). Thus, communication module may include the requisite hardware, firmware, software and/or combinations thereof for establishing and maintaining a network communication connection.

The processor 506 is configured to execute instructions stored in the memory 504 including instructions associated with event requesting module 520. Event requesting module 520 is configured to receive event commitment record information 530 from an event commitment record that is stored in a blockchain network. In specific embodiments of the invention, the event commitment record is a smart contract formed between two users and their respective financial institutions for the purpose of payment for goods or services exchanged between the users. The event commitment record information 530 may be received by the IoT device 500 wirelessly from inputs provided by the user 204 or the event facilitator 202. The event commitment record information 530 includes an event triggering rule 532 associated with one or more of the sensors 510 and an event processing rule 534 that designates the real-time event-mediating channel 210 for processing an associated event request triggered by satisfying the event triggering rule 532.

Further, the event requesting module 520 is configured to monitor 540 the output of the sensors 540 associated with the event triggering rule 532 to determine when the output of the sensors 540 satisfies the event triggering 532. In addition, the event requesting module 520 is configured to, in response to determining that the output of the sensors 510 satisfies the event triggering rule 532, initiate wireless communication, via the distributed communication network to the real-time event-mediating channel 210, of an event request 550 associated with the one of the plurality of predetermined event commitment records. In specific embodiments of the invention the event request 550 includes an event commitment record identifier (ID) 552 that serves to associate the event request 550 with the corresponding event commitment record.

In specific embodiments of the invention, a plurality of inter-related IoT devices/apparatus 500 and/or sensors 510 are implicated in triggering event processing. Each inter-related IoT device/apparatus 500 is configured to communicate with other inter-related IoT devices. For example, in those embodiments of the invention in which the event is a payment for house cleaning services, each room in the house may be equipped with an IoT device having one or more sensors that detects whether the room has been cleaned/serviced. Thus, real-time payment of the cleaning service provider is not initiated until a determination is made that all of the rooms in the house/building have been properly cleaned/serviced.

In such embodiments of the invention, each inter-related IoT device is configured to receive event commitment record information 530 associated with one specific event commitment record. The event commitment record information 530 includes an event triggering rule 532, which may be the same event triggering rule 532 for more than one IoT communication device 500 (i.e., more than one sensor 510) or a different rule for each IoT communication device 500 and/or sensor 510. In such embodiments of the invention, the event request 550 is triggered in response to determining that the output of a plurality of the sensors 510 (i.e., at least two and possibly all of the applicable sensors) satisfy their respective event triggering rule 532). In such embodiments of the invention, the event requesting module 520 is further configured to initiate wireless communication of a notification 560 to one or all other inter-related IoT communication devices 500 associated with the event commitment record that notifies the other inter-related IoT communication devices 500 that their respective sensor output 562 satisfies their respective event triggering rule 532. In this regard, at least one of the intra-related IoT communication devices 500 is configured to determine that the requisite number (i.e., at least two and possibly all) of the IoT communication devices 500 and/or sensors 510 satisfy their respective event triggering rule 534. In other related embodiments of the invention, at least one of the intra-related IoT communication devices 500 is configured to determine in addition to or lieu of determining that the requisite number of the IoT communication devices 500 and/or sensors 510 satisfy their respective event triggering rule 534, that the IoT communication devices 500 and/or sensors 510 that satisfied their respective event triggering rule 534 in a predetermined order or sequence. In response to such a determination, one of the inter-related IoT communication devices 500 is tasked with initiating wireless communication, via the distributed communication network to the real-time event-mediating channel 210, of an event request 550 associated with the one of the plurality of predetermined event commitment records.

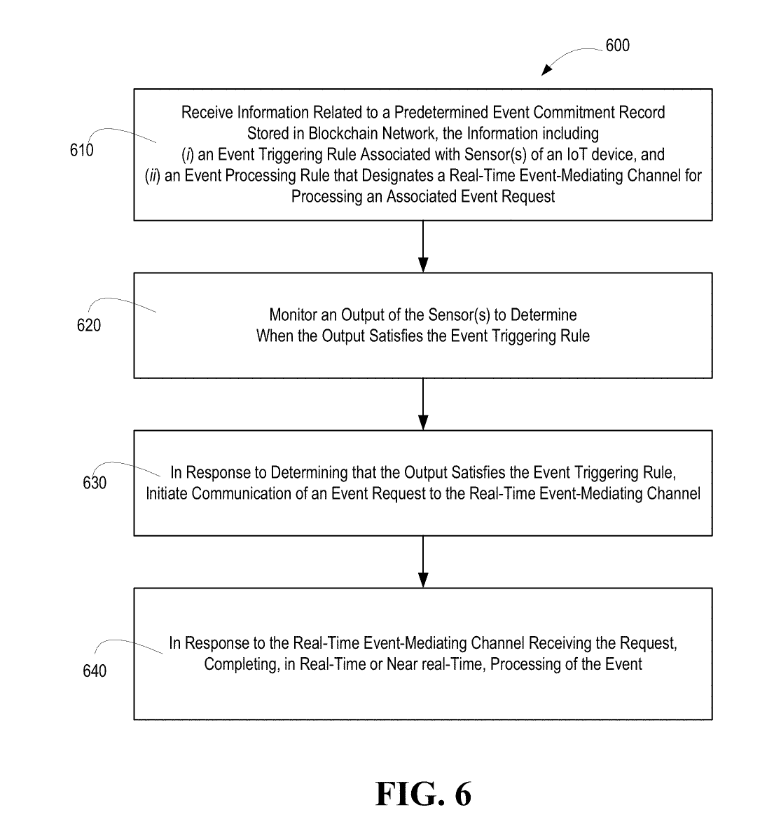

Referring to FIG. 6 a flow diagram is presented of a method 600 for real-time processing of events, in accordance with embodiments of the present invention. At Event 601, an IoT communication device or device in communication with an IoT communication device receives information related to a predetermined event commitment record, e.g., information related to a smart contract that is stored in a blockchain network. The event commitment record is stored in the blockchain network for the purpose of validating the user and authorizing an event facilitator to access a resource depository associated with the event at time of processing the event so as to provide for real-time event processing. The information related to a predetermined event commitment record includes (i) an event triggering rule associated with one or more sensors in the IoT device or in communication with the IoT communication device and (ii) an event processing rule that designates a real-time event-mediating channel for processing an associated event request for performing the associated event.

At Event 620, the output of the sensor(s) associated with the event triggering rule are monitored to determine when the output satisfies the rule. In response to determining that the output of the sensor(s) satisfies the event triggering rule, at Event 630, communication of an event request to the designated real-time event-mediating channel is initiated. As previously discussed in those embodiments of the invention in which the event commitment record includes event triggering rules associated with multiple IoT communication devices and or sensors, all of the rules must be determined to be satisfied prior to initiating communication of the event request to the designated real-time event-mediating channel.

In response to the real-time event-mediating channel receiving the event request, the event is completed in real-time or near real-time. In specific embodiments of the invention, real-time completion of the event is defined as completing transfer of resources from one resource depository associated with a first event facilitator to another resource depository associated with a second event facilitator different from the first event facilitator (e.g., completing the settlement process for transferring funds from one account held at a first financial institution to another account held at a second financial institution).

To supplement the present disclosure, this application further incorporates by reference the following commonly assigned patent applications in their entirety as if set forth fully herein:

| | U.S. Patent | | |
|---|---|---|---|
| | Application | | |
| Docket Number | Ser. No. | Title | Filed On |
| 8333US1.014033.3188 | To be | NETWORK | Con- |
| | assigned | AUTHENTICATION | currently |
| | | FOR REAL-TIME | herewith |
| | | INTERACTION | |
| | | USING | |
| | | PRE-AUTHORIZED | |
| | | DATA RECORD | |
| 8334US1.014033.3189 | To be | REAL-TIME | Con- |
| | assigned | NETWORK | currently |
| | | PROCESSING | herewith |
| | | NUCLEUS | |
| 8335US1.014033.3190 | To be | REAL-TIME DATA | Con- |
| | assigned | PROCESSING | currently |
| | | PLATFORM WITH | herewith |
| | | INTEGRATED | |
| | | COMMUNICATION | |
| | | LINKAGE | |
| 8336US1.014033.3191 | To be | REAL TIME DATA | Con- |
| | assigned | PROCESSING | currently |
| | | PLATFORM | herewith |
| | | FOR RESOURCES | |
| | | ON DELIVERY | |
| | | INTERACTIONS | |

Thus, systems, apparatus, methods, and computer program products described above provide for real-time (or near real-time) processing of computing events that are triggered by a threshold level being met by data detected at Internet-of-Things (IoT) devices and, in response to meeting the threshold, communicating an event processing request to a real-time event-mediating channel. The real-time event-mediating channel is capable of processing such events in real-time or near real-time by storing event commitment records in a distributed blockchain network that authenticates a user associated with an event and authorizes an event facilitating entity to access a resource depository associated with the event.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for real-time event processing, the system comprising:
a distributed communication network comprising a real-time event-mediating channel;
a distributed blockchain network comprising a plurality of decentralized nodes configured to:
store a plurality of predetermined event commitment records configured to authenticate a user and facilitate an event by authorizing a first event facilitating entity associated with the user to access a first resource depository associated with the user at the first event facilitating entity; and
at least one Internet-of-Things (IoT) communication device associated with the user and comprising a processor, a memory storing instructions and in communication with the processor and one or more sensors in communication with the processor, wherein the processor is configured to execute the instructions stored in the memory to:
receive, via the distributed communication network, information related to one of the predetermined event commitment records, wherein the information includes (i) an event triggering rule associated with at least one of the sensors, and (ii) an event processing rule designating the real-time event-mediating channel for processing an associated event request,
monitor an output of the at least one of the sensors to determine when the output satisfies the event triggering rule, and
in response to determining that the output satisfies the event triggering rule, initiate wireless communication, via the distributed communication network to the real-time event-mediating channel, of an event request associated with the one of the plurality of predetermined event commitment records,
wherein the real-time event-mediating channel is configured to, in response to receiving the event request, complete the event in real-time or near real-time to receiving the event request.

2. The system of claim 1, wherein the event is a transfer of resources from the first resource depository to a second resource depository associated with a second event facilitating entity.

3. The system of claim 1, wherein the processor of the IoT communication device is further configured to execute the instructions to receive, via the distributed communication network, the information related to one of the predetermined event commitment records, wherein the information includes (i) the event triggering rule associated with at least one of the sensors, wherein the event triggering rule is a minimum threshold limit associated with a consumable product consumed by the IoT communication device or a device associated with the IoT communication device.

4. The system of claim 3, wherein the processor of the IoT communication device is further configured to, in response to determining that the output satisfies the event triggering rule, execute the instructions to initiate wireless communication, via the distributed communication network, of an acquisition request to a designated consumable product provider to acquire the consumable product.

5. The system of claim 1, wherein the processor of the IoT communication device is further configured to execute the instructions to receive, via the distributed communication network, the information related to one of the predetermined event commitment records, wherein the information includes (i) the event triggering rule associated with at least one of the sensors, wherein the event triggering rule is a threshold limit associated with performance of a service performed by a service provider.

6. The system of claim 1, wherein the at least one IoT communication device further comprises a plurality of inter-related IoT communication devices, wherein the processors of the inter-related IoT communication devices, are further configured to:
in response to determining that the output of the at least sensor of one of the plurality of inter-related IoT communication devices satisfies the inter-related IoT communication device-specific event triggering rule, initiate wireless communication, via the distributed communication network, of a notification to at least one of the plurality of inter-related IoT communication devices that notifies the at least one the inter-related IoT communication device that the output satisfies the event triggering rule, and
in response to receiving the notification from at least a designated minimum quantity of the plurality of inter-related IoT communication devices, initiate wireless communication, via the distributed communication network to the real-time event-mediating channel, of an event request associated with the one of the plurality of predetermined event commitment records.

7. The system of claim 1, wherein the at least one IoT communication device further comprises a plurality of inter-related IoT communication devices, wherein the processors of the inter-related IoT communication devices, are further configured to:
in response to determining that the output of the at least sensor of one of the plurality of inter-related IoT communication devices satisfies the inter-related IoT communication device-specific event triggering rule, initiate wireless communication, via the distributed communication network, of a notification to at least one of the plurality of inter-related IoT communication devices that notifies the at least one the inter-related IoT communication device that the output satisfies the event triggering rule,
in response to receiving the notification from the plurality of inter-related IoT communication devices, determine that the event triggering rules have been satisfied in a predetermined sequence, and
in response to determining that the event triggering rules have been satisfied in the predetermined sequence, initiate wireless communication, via the distributed communication network to the real-time event-mediating channel, of an event request associated with the one of the plurality of predetermined event commitment records.

8. The system of a claim 1, wherein the real-time event-mediating channel is further configured to, in response to receiving the event request, authenticate the user and authorize the first event facilitating entity associated with the user to access the first resource depository at the first event facilitating entity based on the one of the predetermined event commitment records stored in the distributed blockchain network.

9. The system of claim 8, wherein the real-time event-mediating channel is further configured to, in response to receiving the event request, access the one of the predetermined event commitment records in the distributed blockchain network to authenticate the user and authorize the first event facilitating entity associated with the user to access the first resource depository at the first event facilitating entity.

10. The system of claim 8, wherein the real-time event-mediating channel is further configured to, in response to receiving the event request, communicate an authentication and authorization request to the first event facilitating entity to access the one of the predetermined event commitment records in the distributed blockchain network to authenticate the user and authorize the first event facilitating entity to access the first resource depository at the first event facilitating entity.

11. An Internet-of-Things (IoT) communication apparatus, the apparatus comprising:
at least one processor;
a memory storing instructions and in communication with the at least one processor;
a wireless communication mechanism in communication with one or more of the at least one processors; and
at least one sensor in communication with one or more of the at least one processors,
wherein the processor is configured to execute the instructions to:
receive, via the wireless communication mechanism, information related to a predetermined event commitment record stored within a distributed blockchain network, wherein the information includes (i) an event triggering rule associated with at least one of the sensors, and (ii) an event processing rule that designates a real-time event-mediating channel for processing an associated event request,
monitor an output of the at least one of the sensors to determine when the output satisfies the event triggering rule, and
in response to determining that the output satisfies the event triggering rule, initiate communication, via the wireless communication mechanism, of an event request to the real-time event-mediating channel.

12. The apparatus of claim 11, wherein, in response to receiving the event request, the real-time event-mediating channel is configured to complete the event in real-time or near real-time to receiving the event request.

13. The apparatus of claim 12, wherein in response to receiving the event request, the real-time event-mediating channel is configured to complete the event, wherein the event is a transfer of resources from a first resource depository associated with a first resource transfer entity to a second resource depository associated with a second resource transfer entity.

14. The apparatus of claim 11, wherein the processor is further configured to execute the instructions to receive, via the wireless communication mechanism, the information related to one of the predetermined event commitment records, wherein the information includes (i) the event triggering rule associated with at least one of the sensors, wherein the event triggering rule is a minimum threshold limit associated with a consumable product consumed by the IoT communication device or a device associated with the IoT communication device.

15. The apparatus of claim 11, wherein the processor is further configured to receive, via the wireless communication mechanism, the information related to one of the predetermined event commitment records, wherein the information includes (i) the event triggering rule associated with at least one of the sensors, wherein the event triggering rule is a threshold limit associated with performance of a service performed by a service provider.

16. The apparatus of claim 11, the processor is further configured to, in response to determining that the output satisfies the event triggering rule, initiate wireless communication, via the distributed communication network, of a notification to at least one of a plurality of inter-related IoT communication devices that notifies the at least one of the inter-related IoT communication devices that the output satisfies the event triggering rule.

17. The apparatus of claim 11, the processor is further configured to:
in response to determining that the output satisfies the event triggering rule, receive wireless communication, via the distributed communication network, one or more notifications from at least one inter-related IoT communication devices that notifies the IoT communication device that an output of a sensor associated with the inter-related IoT communication device satisfies an associated event triggering rule, and
in response receiving the notification from at least a designated minimum quantity of the plurality of inter-related IoT communication devices, initiate the wireless communication, via the distributed communication network to the real-time event-mediating channel, of the event request associated with the one of the plurality of predetermined event commitment records.

18. A computer program product including a non-transitory computer-readable medium, the computer-readable medium comprising:
a first set of codes for causing a computer to receive, via wireless communication, information related to a predetermined event commitment records stored in distributed blockchain network, wherein the information includes (i) an event triggering rule associated with at least one sensor of an Internet-of-Things (IoT) device, and (ii) an event processing rule that designates a real-time event-mediating channel for processing an associated event request,
a second set of codes for causing a computer to monitor an output of the at least one of the sensors to determine when the output satisfies the event triggering rule, and
a third set of codes for causing a computer to, in response to determining that the output satisfies the event triggering rule, initiate communication, via wireless communication, of an event request to the real-time event-mediating channel.

19. The computer program product of claim 18, wherein, in response to receiving the event request, the real-time event mediating channel is configured to complete, in real-time or near real-time to receiving the event request, a transfer of resources from a first resource depository associated with a first resource transfer entity to a second resource depository associated with a second resource transfer entity.

20. The computer program product of claim 18, wherein the first set of codes is further configured to receive, via the wireless communication mechanism, the information related to one of the predetermined event records, wherein the information includes (i) the event triggering rule associated with at least one of the sensors, wherein the event triggering rule is one of (a) a minimum threshold limit associated with a consumable product consumed by the IoT communication device or a device associated with the IoT communication device, and (b) a threshold limit associated with performance of a service performed by a service provider.
